(19) United States
(12) Patent Application Publication
(10) Pub. No.: US 2014/0240895 A1
(43) Pub. Date: Aug. 28, 2014

(54) MULTILAYER CERAMIC CAPACITOR AND METHOD OF MANUFACTURING THE SAME

(71) Applicant: SAMSUNG ELECTRO-MECHANICS CO., LTD., SUWON (KR)

(72) Inventors: Jong Ho LEE, Suwon (KR); Eung Soo KIM, Suwon (KR); Jae Yeol CHOI, Suwon (KR); Doo Young KIM, Gyunggi-do (KR); Yu Na KIM, Suwon (KR); Sung Woo KIM, Suwon (KR)

(73) Assignee: SAMSUNG ELECTRO-MECHANICS CO., LTD., Suwon (KR)

(21) Appl. No.: 13/897,162

(22) Filed: May 17, 2013

(30) Foreign Application Priority Data
Feb. 25, 2013 (KR) 10-2013-0019959

(51) Int. Cl. H01G 4/12

(52) U.S. Cl. CPC H01G 4/12
USPC 361/301.4; 29/25.42

(57) ABSTRACT

A multilayer ceramic capacitor includes a ceramic body having dielectric layers laminated therein; an active layer including first and second internal electrodes alternately exposed through end surfaces of the ceramic body having the dielectric layer interposed therebetween; upper and lower cover layers formed above and below the active layer; first and second external electrodes formed on end surfaces of the ceramic body, respectively; first and second dummy patterns extended from the first and second external electrodes into margin portions of the active layer in a length direction, respectively; and first and second dummy electrodes opposing each other in a length direction within the upper and lower cover layers, the first and second dummy electrodes being extended inwardly from the first and second external electrodes.

### CROSS-REFERENCE TO RELATED APPLICATIONS

This application claims the priority of Korean Patent Application No. 10-2013-0019959 filed on Feb. 25, 2013, in the Korean Intellectual Property Office, the disclosure of which is incorporated herein by reference.

### BACKGROUND OF THE INVENTION

1. Field of the Invention

The present invention relates to a multilayer ceramic capacitor and a method of manufacturing the same.

2. Description of the Related Art

A multilayer ceramic capacitor (MLCC), a multilayer chip electronic component, is a chip type condenser mounted on printed circuit boards of various electronic products, such as image display devices including liquid crystal displays (LCDs) and plasma display panels (PDPs), computers, personal digital assistants (PDAs), mobile phones, and the like, and allowing for the charging and discharging of electricity therein, since MLCCs have favorable characteristics therefor, such as compactness, high degrees of capacitance, and ease of mountability.

The multilayer ceramic capacitor may have a structure in which a plurality of dielectric layers are alternately laminated with a plurality of internal electrodes having different polarities disposed between the dielectric layers.

Here, when the internal electrodes are printed, margin portions having a predetermined width are provided on edges of the dielectric layers. For this reason, a step having a certain height may be generated between the margin portions and the internal electrodes in a length direction of the multilayer ceramic capacitor.

In the manufacturing process, when a plurality of ceramic green sheets on which internal electrodes are printed are laminated and compressed, there may be a limit to the shrinkage of the margin portion having a step with regard to the internal electrode. Therefore, delamination in which laminated dielectric layers are separated from each other may occur in a certain amount of multilayer ceramic capacitors.

Therefore, during a plating process and in the driving of a multilayer ceramic capacitor, the penetration of moisture, ions, and conductive foreign objects into internal electrodes exposed by delaminated dielectric layers may occur, resulting in deteriorated reliability of the multilayer ceramic capacitor.

In particular, this problem may occur in ultra-high capacitance products in which large numbers of sheets are laminated.

Patent Document 1 discloses a multilayer ceramic capacitor having dummy patterns. However, the dummy patterns disclosed in Patent Document 1 intersect with internal electrodes. In addition, Patent Document 1 fails to disclose a structure in which dummy electrodes are formed in upper and lower portions of a ceramic body.

### RELATED ART DOCUMENTS

(Patent Document 1) Korean Patent Laid-Open Publication No. 10-2011-0027321

### SUMMARY OF THE INVENTION

An aspect of the present invention provides a multilayer ceramic capacitor capable of suppressing the occurrence of delamination or allowing delamination to occur in a portion thereof in which reliability of a chip will not be affected, even in the case of the occurrence of delamination.

According to an aspect of the present invention, there is provided a multilayer ceramic capacitor, including: a ceramic body having a plurality of dielectric layers laminated therein; an active layer including a plurality of first and second internal electrodes alternately exposed through both end surfaces of the ceramic body having the dielectric layer interposed therebetween; upper and lower cover layers formed above and below the active layer; first and second external electrodes formed on both end surfaces of the ceramic body and electrically connected to exposed portions of the plurality of first and second internal electrodes, respectively; a plurality of first and second dummy patterns respectively extended from the first and second external electrodes into margin portions of the active layer in a length direction so as to oppose the plurality of first and second internal electrodes, respectively; and a plurality of first and second dummy electrodes opposing each other in a length direction in the upper and lower cover layers, the first and second dummy electrodes being extended inwardly from the first and second external electrodes within the upper and lower cover layers.

Here, when a width of the first and second dummy patterns is denoted by a and a gap between the first or second dummy pattern and the first or second internal electrode is denoted by b, 0.2≦a/(a+b)≦0.8 may be satisfied.

The plurality of first and second dummy patterns may have an equal width.

Here, a certain amount of dummy patterns among the plurality of first and second dummy patterns may have different widths.

The first and second dummy electrodes may have an equal width.

Here, a certain amount of dummy electrodes among the plurality of first and second dummy electrodes may have different widths.

The first and second dummy electrodes formed in the upper and lower cover layers may be symmetrical with respect to each other in a thickness direction of the ceramic body.

The lower cover layer may have a greater thickness than that of the upper cover layer.

The multilayer ceramic capacitor may further include first and second plating layers formed on both end surfaces of the ceramic body to cover the first and second external electrodes.

According to another aspect of the present invention, there is provided a method of manufacturing a multilayer ceramic capacitor, the method including: laminating a plurality of first ceramic green sheets having a plurality of first and second dummy electrodes respectively formed thereon, laminating an active layer formed by alternately laminating a plurality of second ceramic green sheets and a plurality of third ceramic green sheets, the second ceramic green sheet having a first internal electrode and a first dummy pattern formed thereon, the third ceramic green sheet having a second internal electrode and a second dummy pattern formed thereon, and laminating a plurality of fourth ceramic green sheets having a plurality of first and second dummy electrodes respectively formed thereon, to thereby forma laminate; cutting the laminate into ceramic bodies while allowing the first and second dummy electrodes of upper and lower portions of the laminate, the first and second internal electrodes and the first and second dummy patterns to be exposed through both end surfaces of the respective ceramic bodies; sintering the respective ceramic bodies; and forming first and second external electrodes on both end surfaces of the respective ceramic bodies to cover exposed portions of the first and second dummy electrodes, the first and second internal electrodes, and the first and second dummy patterns.

Here, in the forming of the laminate, the first and second dummy patterns and the first and second internal electrodes may be formed on the second and third ceramic green sheets, respectively, such that 0.2≦a/(a+b)≦0.8 may be satisfied when a width of the first and second dummy patterns is denoted by a and a gap between the first or second dummy pattern and the first or second internal electrode is denoted by b.

Here, in the forming of the laminate, the first and second dummy patterns may be formed on the second and third ceramic green sheets, respectively, such that the first and second dummy patterns may have an equal width.

Here, in the forming of the laminate, the first and second dummy patterns may be formed on the second and third ceramic green sheets, respectively, such that a certain amount of dummy patterns among the first and second dummy patterns may have different widths.

Here, in the forming of the laminate, the first and second dummy electrodes may be formed on the first and fourth ceramic green sheets, such that the first and second dummy electrodes may have an equal width.

Here, in the forming of the laminate, the first and second dummy electrodes may be formed on the first and fourth ceramic green sheets, such that a certain amount of dummy patterns among the first and second dummy electrodes may have different widths.

Here, in the forming of the laminate, the first and second dummy electrodes may be formed on the first and fourth ceramic green sheets, such that the first and second dummy electrodes are symmetrical with respect to each other in a thickness direction of the respective ceramic bodies.

Here, in the forming of the laminate, the lower portion of the laminate may have a greater thickness than that of the upper portion of the laminate by laminating the first ceramic green sheets in greater amounts than the fourth ceramic green sheets.

The method may further include, after the forming of the first and second external electrodes, forming first and second plating layers on both end surfaces of the respective ceramic bodies to cover the first and second external electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a multilayer ceramic capacitor according to an embodiment of the present invention;

FIG. 2 is a cross-sectional view taken along line A-A′ of FIG. 1;

FIG. 3 is an exploded perspective view showing a ceramic body of the multilayer ceramic capacitor according to the embodiment of the present invention;

FIG. 4 is a perspective view showing a cross section of a ceramic body of the multilayer ceramic capacitor according to the embodiment of the present invention;

FIG. 5 is a perspective view showing first and second dummy electrodes formed in an upper or lower cover layer of FIG. 2 and

FIG. 6 is a cross-sectional view showing a chip cutting process in a method of manufacturing a multilayer ceramic capacitor according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

In the present embodiments, for convenience of explanation, surfaces of a ceramic body on which first and second external electrodes are formed in a length direction of the ceramic body are defined as end surfaces, and surfaces of the ceramic body perpendicular to the end surfaces are defined as side surfaces.

Multilayer Ceramic Capacitor

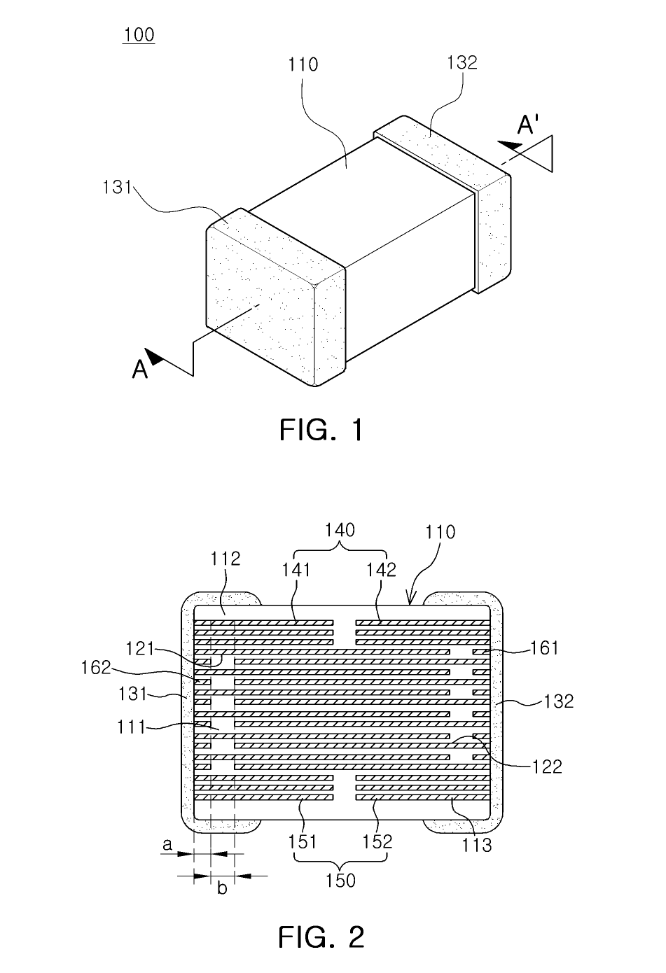

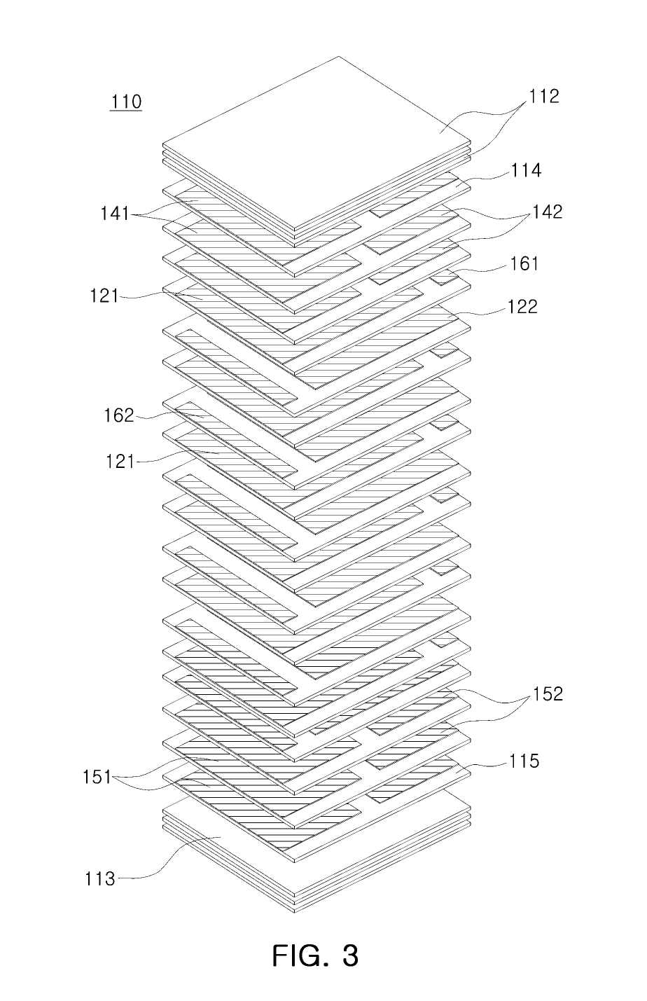

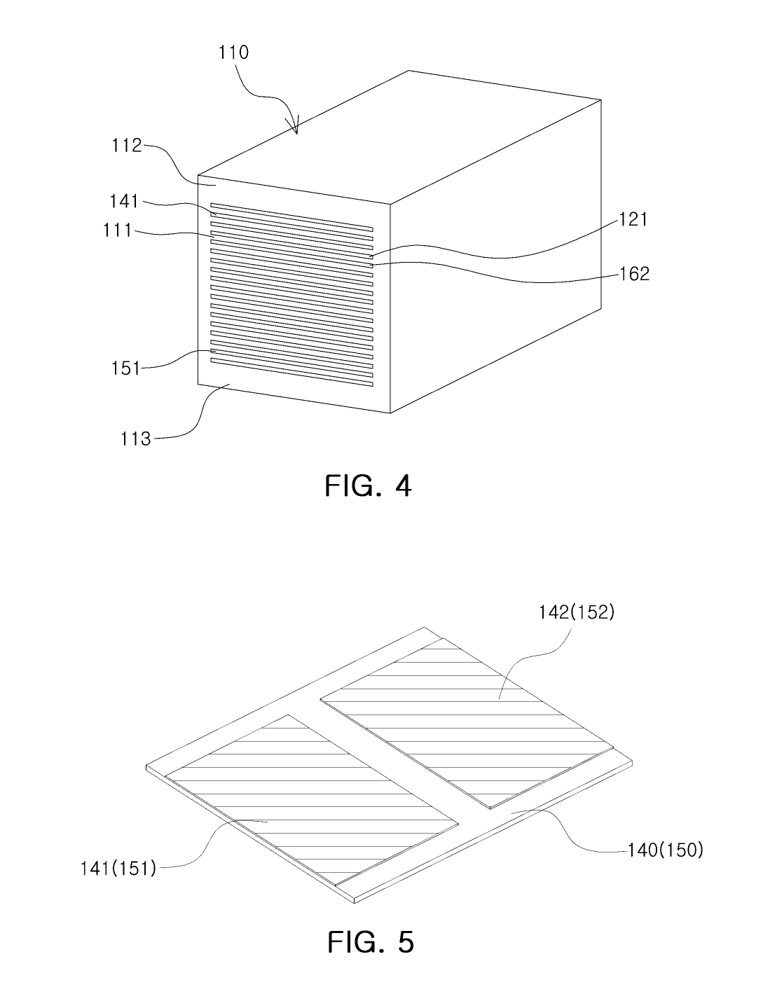

Referring to FIGS. 1 and 4, a multilayer ceramic capacitor 100 according to an embodiment of the invention may include: a ceramic body 110, an active layer having a plurality of first and second internal electrodes 121 and 122, upper and lower cover layers 114 and 115 respectively formed above and below the active layer, and first and second external electrodes 131 and 132 covering both end surfaces of the ceramic body 110.

First and second dummy patterns 161 and 162 maybe formed to oppose the first and second internal electrodes 121 and 122, respectively, in the active layer. A plurality of dummy electrodes 140 and 150 may be formed to oppose each other in the upper and lower cover layers 114 and 115.

The ceramic body 110 may be formed by laminating and sintering a plurality of dielectric layers 111. The shape and dimensions of the ceramic body 110 and the number of dielectric layers 111 are not limited to those exemplified in the present embodiment.

In addition, the plurality of dielectric layers 111 constituting the ceramic body 110 are in a sintered state, and boundaries between adjacent dielectric layers 111 may be integrated with each other such that they may not be readily apparent without the use of a scanning electron microscope (SEM).

The ceramic body 110 maybe composed of the active layer contributing to capacitance formation and the upper and lower cover layers 114 and 115 formed as upper and lower margin portions, disposed above and below the active layer 115, respectively.

The active layer may be formed by repeatedly alternately laminating the plurality of first and second internal electrodes 121 and 122 with the dielectric layer 111 interposed therebetween.

Here, the thickness of the dielectric layer 111 may be optionally changed according to intended capacitance of the multilayer ceramic capacitor 100, and the thickness of a single dielectric layer may be 0.01 to 1.00 μm after sintering, but the invention is not limited thereto.

In addition, the dielectric layer 111 may contain a ceramic powder having high permittivity, for example, a barium titanate (BaTiO₃)-based powder or a strontium titanate (SrTiO₃)-based powder, but the invention is not limited thereto.

The upper and lower cover layers 114 and 115 may have the same material and constitution as the dielectric layer 111, except that the upper and lower cover layers 114 and 115 do not include internal electrode films.

The upper and lower cover layers 114 and 115 may be formed by laminating a single dielectric layer or two or more dielectric layers on upper and lower surfaces of the active layer 115 in upward and downward directions, respectively. The upper and lower cover layers 114 and 115 may fundamentally serve to prevent damage to the first and second internal electrodes 121 and 122 due to physical or chemical stress.

In addition, the number of laminated dielectric layers may be equal in the upper and lower cover layers 114 and 115, but the invention is not limited thereto. As necessary, the lower cover layer 115 may have a greater thickness than that of the upper cover layer 114 by increasing the number of dielectric layers as compared with the upper cover layer 114.

Here, as necessary, one or more ceramic cover layers 112 and 113 on which electrode films are not formed may be formed on the outermost surfaces of the ceramic body 110, that is, upper and lower surfaces of the upper and lower cover layers 114 and 115, respectively, as shown in the drawings.

The first and second internal electrodes 121 and 122 are pairs of electrodes having different polarities, and may be formed by printing a conductive paste containing a conductive metal on each of the dielectric layers 111 to a predetermined thickness while the first and second internal electrodes 121 and 122 are alternately exposed through both end surfaces of the ceramic body. The first and second internal electrodes 121 and 122 may be electrically insulated from each other by the dielectric layers 111 interposed therebetween.

The first and second internal electrodes 121 and 122 may be electrically connected to the first and second external electrodes 131 and 132 through portions thereof alternately exposed through both end surfaces of the ceramic body 110.

Therefore, when voltages are applied to the first and second external electrodes 131 and 132, charges are built between the first and second internal electrodes 121 and 122 facing each other. Here, the capacitance of the multilayer ceramic capacitor 100 is proportional to the area of an overlapping region of the first and second internal electrodes 121 and 122.

The thickness of each of the first and second internal electrodes 121 and 122 may be determined depending on the intended usage thereof, and for example, may be determined within a range of 0.2 to 1.0 μm in consideration of the size of the ceramic body 110. However, the invention is not limited thereto.

In addition, a conductive metal contained in the conductive paste for forming the first and second internal electrodes 121 and 122 may be nickel (Ni), copper (Cu), palladium (Pd), or alloys thereof, but the invention is not limited thereto.

In addition, the conductive paste may be printed by a screen printing method, a gravure printing method, or the like, but the invention is not limited thereto.

The first and second dummy patterns 161 and 162 may be positioned on the same plane as the first and second internal electrodes 121 and 122 within the active layer 115. The first and second dummy patterns 161 and 162 may be formed by printing a conductive paste containing a conductive metal on the dielectric layers 111 at a predetermined thickness through the same method as the first and second internal electrodes 121 and 122. Here, the first and second dummy patterns 161 and 162 may be alternately exposed through the end surfaces of the ceramic body 110 opposed to the end surfaces thereof, through which the first and second internal electrodes 121 and 122 are exposed, to thereby be connected to the first and second external electrodes 131 and 132.

Here, a gap between the first internal electrode 121 and the first dummy pattern 161 and a gap between the second internal electrode 122 and the second dummy pattern 162 may be offset in the length direction of the ceramic body.

In addition, the widths a of the first and second dummy patterns 161 and 162 may be equal to each other or certain dummy patterns among the first and second dummy patterns 161 and 162 may have different widths to others thereof.

The first and second dummy patterns 161 and 162 may be formed by printing the same material as the first and second internal electrodes 121 and 122, that is, a conductive paste containing a conductive metal, on the dielectric layers 111.

Here, the conductive metal may be nickel (Ni), copper (Cu), palladium (Pd), or alloys thereof, but the invention is not limited thereto.

The first and second dummy patterns 161 and 162 reduce an influence of step height in the length direction of the multilayer ceramic capacitor 100, thereby suppressing the occurrence of delamination. Preferably, when the width of the first and second dummy patterns 161 and 162 is denoted by ‘a’ and a gap between the first or second dummy pattern 161 or 162 and the first or second internal electrode 121 or 122 is denoted by ‘b,’ 0.2≦a/(a+b)≦0.8 may be satisfied.

Table 1 shows the occurrence or non-occurrence of delamination and short circuits, and the 8585 test results, in which, during application of load for 1 hour under conditions of about 85° C., relatively humidity of 85%, and 6.3 V, it was determined NG when even at least one IR is deteriorated to be below 1e4 Ω.

TABLE 1

| | | | | | Short, | 8585 |
|---|---|---|---|---|---|---|
| | a [μm] | b [μm] | a/(a + b) | Delam | % | Test |
| Comparative | 5 | 95 | 0.05 | 16/50 | 37 | NG |
| Example 1 | | | | | | |
| Comparative | 10 | 90 | 0.1 | 4/50 | 12 | NG |
| Example 2 | | | | | | |
| Inventive | 20 | 80 | 0.2 | 0/50 | 0 | OK |
| Example 1 | | | | | | |
| Inventive | 30 | 70 | 0.3 | 0/50 | 2 | OK |
| Example 2 | | | | | | |
| Inventive | 50 | 50 | 0.5 | 0/50 | 0 | OK |
| Example 3 | | | | | | |
| Inventive | 60 | 40 | 0.6 | 0/50 | 1 | OK |
| Example 4 | | | | | | |
| Inventive | 80 | 20 | 0.8 | 0/50 | 0 | OK |
| Example 5 | | | | | | |
| Comparative | 90 | 10 | 0.9 | 0/50 | 83 | NG |
| Example 3 | | | | | | |
| Comparative | 95 | 5 | 0.95 | 0/50 | 100 | NG |
| Example 4 | | | | | | |

Referring to Table 1, in Comparative Examples 1 and 2 in which the a/(a+b) value was below 0.2, step height was not insufficiently reduced and thus the effect of suppressing the occurrence of delamination was decreased, resulting in delamination. In Comparative Examples 3 and 4 in which the a/(a+b) value was above 0.8, step height was steeply generated in the gap b and thus reliability was deteriorated.

Referring to FIG. 5, the dummy electrodes 140 and 150 of the present embodiment will be described in detail.

In the present embodiment, the dummy electrode 150 having first and second dummy electrodes 151 and 152 and formed in the lower cover layer 115 may be symmetrical with the dummy electrode 140 formed in the upper cover layer 114 in a thickness direction of the ceramic body 110. Since the constitutions of the dummy electrodes 150 and 140 are similar, only the dummy electrode 140 formed in the upper cover layer 114 will be described to obviate overlapping descriptions.

The dummy electrode 140 of the upper cover layer 114 may be composed of pairs of first and second dummy electrodes 141 and 142 on left and right sides. Here, the first and second dummy electrodes 141 and 142 may have an equal width, or as necessary, certain dummy electrodes among the first and second dummy electrodes 141 and 142 may have different widths.

That is, in the present embodiment, the first and second dummy electrodes 141 and 142 may have equal widths and may be formed as a leftward and rightward symmetrical structure based on the centerline of the ceramic body 110 in the length direction, but the invention is not limited thereto. Certain dummy electrodes of the first and second dummy electrodes 141 and 142 may have different widths. Alternatively, even in the case of dummy electrodes disposed in the same direction, a certain amount thereof may have different widths.

The first and second dummy electrodes 141 and 142 may be exposed through both end surfaces of the ceramic body 110, and the exposed portions may be in contact with, and thus electrically connected to, the first and second external electrodes 131 and 132, respectively.

The first and second dummy electrodes 141 and 142 may reduce the step height of the ceramic body 110 to suppress the occurrence of delamination, or may serve as a protecting layer to allow delamination to occur between the first and second dummy electrodes 141 or 142, not between the first and second internal electrodes 121 and 122 even in the case that delamination occurs.

Here, in the case in which excessive amounts of dummy electrodes 140 and 150 are laminated in the upper and lower portions of the ceramic body 110, a chip size may be excessively enlarged.

Therefore, the cover layers 114 and 115 having the dummy electrodes 140 and 150 may have a thickness within a range in which step height can be suppressed, for example, a thickness of 10 to 20% of the thickness of the dielectric layers 111 having the first and second internal electrodes 121 and 122 thereon, but the invention is not limited thereto.

The first and second dummy electrodes 140 and 150 may be formed by printing the same material as the first and second internal electrodes 121 and 122, that is, a conductive paste containing a conductive metal, on the upper and lower cover layers 114 and 115.

Here, the conductive metal may be nickel (Ni), copper (Cu), palladium (Pd), or alloys thereof, but the invention is not limited thereto.

The first and second external electrodes 131 and 132 may be formed of a conductive paste containing a conductive metal.

Here, the conductive metal may be nickel (Ni), copper (Cu), palladium (Pd), gold (Au), or alloys thereof, but the invention is not limited thereto.

In addition, as necessary, first and second plating layers (not shown) of nickel or tin may be further formed to cover the first and second external electrodes 131 and 132.

Operations of the multilayer ceramic capacitor 100 according to the present embodiment will be described.

Dielectric layers have predetermined margin portions between first and second internal electrodes.

The margin portions of the dielectric layers may serve to prevent foreign objects from penetrating into the first and second internal electrodes after the dielectric layers are laminated to form a ceramic body, and may serve to prevent electric short circuits by protecting the first and second internal electrodes from external impacts.

Here, when ceramic green sheets are laminated and then compressed, step height between the first and second internal electrodes and the margin portions may cause delamination at the corners of the ceramic body, through which moisture, ions, and conductive foreign objects may penetrate into exposed portions of the first and second internal electrodes, resulting in decreased insulation resistance and deteriorated reliability.

Here, in the case in which all of the dielectric layers have the first and second internal electrodes provided thereon, the widths of the margin portions may be increased and thus, the above problem may be reduced.

However, the influence of step height at the corners of the ceramic body is increased, and the movement of materials into step portions may be insufficient during the compressing process, resulting in decreased density of the margin portions, and thus cracks may occur.

In addition, in order to fill empty step portions, the internal electrodes may be extended and disconnection of the internal electrodes may be aggravated, and thus, reliability may be deteriorated.

However, in the multilayer ceramic capacitor 100 according to the present embodiment, the dummy electrodes 140 and 150 are formed on the upper and lower cover layers 114 and 115 of the ceramic body 110 to thereby form margin portions at the corners of the ceramic body 110, so that the first and second internal electrodes 121 and 122 functioning as an actual electric connection are spaced apart from the corners, a main penetration path of foreign objects, and delamination may occur in the dummy electrodes 140 and 150, even in the case of the occurrence of delamination, to thereby prevent foreign objects from penetrating into the first and second internal electrodes 121 and 122. As a result, product reliability can be improved.

Therefore, this structure may reduce the possibility of penetration of conductive foreign objects into the corners of the ceramic body on which the external electrodes are coated to have a reduced thickness, in an ultra-high capacitance model having narrow margins and thin covering while maintaining electrode connectivity, and thus reliability can be improved.

### Method of Manufacturing Multilayer Ceramic Capacitor

Hereinafter, a method of manufacturing a multilayer ceramic capacitor 100 according to an embodiment of the invention will be described.

First, a plurality of ceramic green sheets are prepared.

The ceramic green sheets are used for forming dielectric layers 111 constituting a ceramic body 110. The ceramic green sheets may be formed by mixing a ceramic powder of barium titanate (BaTiO₃) or the like, a polymer, a solvent, and the like, to prepare a slurry, and then coating and drying the slurry on carrier films through a doctor blade method or the like, to prepare sheets having a thickness of several micrometers.

Hereinafter, for convenience of explanation, the ceramic green sheets are differentiated into a first ceramic green sheet constituting a lower cover layer 115, second and third ceramic green sheets constituting an active layer, and a fourth ceramic green sheet constituting an upper cover layer 114, depending on the constitution position of the ceramic body 110.

Then, a conductive paste is printed on the first to fourth ceramic green sheets at a predetermined thickness, respectively.

The conductive paste may be printed by a screen printing method, a gravure printing method, or the like, but the invention is not limited thereto.

Here, the conductive paste printed on the first to fourth ceramic green sheets forms a plurality of dummy electrodes 140 and 150 exposed through both end surfaces of the first to fourth ceramic green sheets. The conductive paste printed on the second and third ceramic green sheets forms a plurality of first and second internal electrodes 121 and 122 and a plurality of first and second dummy patterns 161 and 162, exposed through both end surfaces of the second and third ceramic green sheets.

The dummy electrodes 140 and 150, the first and second internal electrodes 121 and 122, and the first and second dummy patterns 161 and 162 may be formed to be differentiated from each other by printing the conductive paste on respective ceramic green sheets to have an offset with respect to the thickness direction.

In addition, the dummy electrodes 140 and 150 may be formed on the first and fourth ceramic green sheets such that, after the cutting process of the ceramic laminate, a pair of left and right first and second dummy electrodes 141, 142, 151, and 152 are symmetrical with respect to each other in a length direction, based on the center of the first and fourth ceramic green sheets, but the invention is not limited thereto.

For example, as necessary, the first and second dummy electrodes 141, 142, 151, and 152 may be formed on the first and fourth ceramic green sheets such that, after the cutting process of the ceramic laminate, the first and second dummy electrodes 141, 142, 151, and 152 are asymmetrical with respect to each other in a length direction, based on the center of the first and fourth ceramic green sheets.

When a width of the first and second dummy patterns 161 and 162 is denoted by ‘a,’ and a gap between the first or second dummy pattern 161 or 162 and the first or second internal electrode 121 or 122 is denoted by ‘b,’ 0.2≦a/(a+b)≦0.8 may be satisfied.

In the case in which a/(a+b) is below 0.2, step height may be slightly reduced and thus delamination may occur. In the case in which a/(a+b) is above 0.8, step height may be steeply generated in the gap b and thus reliability may be deteriorated.

In addition, the first and second dummy patterns 161 and 162 may be formed on the second and third ceramic green sheets to have an equal width, but the invention is not limited thereto.

For example, as necessary, the first and second dummy patterns 161 and 162 may be formed on the second and third ceramic green sheets to have different widths.

Then, a plurality of first ceramic green sheets may be laminated to form the lower cover layer 115; a plurality of second and third ceramic green sheets may be alternately laminated on the lower cover layer 115 to form an active layer; and a plurality of fourth ceramic green sheets may be laminated on the active layer to form the upper cover layer 114.

Thereafter, isostatic pressing may be conducted under conditions of a temperature of about 85° C. and a pressure of about 1,000 kgf/cm², to thereby form the ceramic laminate.

Here, the same number of first and fourth ceramic green sheets may be laminated such that the dummy electrodes 140 and 150 formed in the upper and lower cover layers 114 and 115 are symmetrical with respect to each other in a thickness direction of the ceramic laminate, but the invention is not limited thereto.

For example, the first ceramic green sheets may be laminated in greater amounts than the fourth ceramic green sheets, so that the lower cover layer may be formed to be thicker than the upper cover layer and the number of dummy electrodes 150 in the lower portion of the ceramic laminate is provided to be greater than the number of dummy electrodes 140 in the upper portion of the ceramic laminate.

In addition, one or more dielectric layers having no electrode films may be laminated on upper and lower surfaces of the ceramic laminate, respectively, to form ceramic cover layers 112 and 113.

Then, the ceramic laminate is cut in each respective region corresponding to each multilayer ceramic capacitor, thereby forming individual chips.

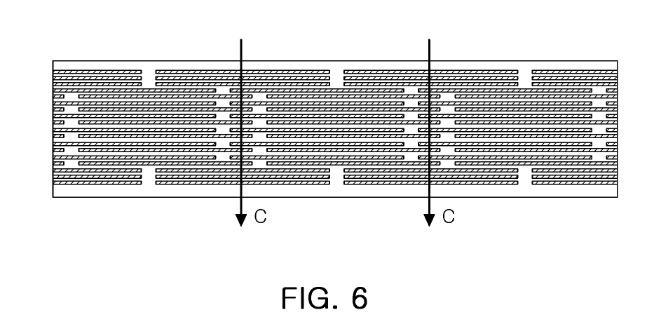

Here, the ceramic laminate may be formed by lamination of single patterns of the lower cover layer 115, the active layer, and the upper cover layer 114, and thus, as shown in FIG. 6, the ceramic laminate may be cut into individual chips along a cutting line (C).

Then, the chip-sized ceramic laminate may be sintered at about 1200° C. in a reducing atmosphere under an oxygen partial pressure of 10⁻¹¹ to 10⁻¹⁰ atm, which is lower than an equilibrium oxygen partial pressure of Ni/NiO, in order to prevent the first and second internal electrodes from being oxidized, to thereby form a ceramic body 110.

Then, first and second external electrodes 131 and 132 may be formed on both end surfaces of the ceramic body 110, to cover and thus be connected to exposed portions of the first and second internal electrodes 121 and 122, the first and second dummy patterns 161 and 162, and the first and second dummy electrodes 141, 142, 151, and 152, whereby a multilayer ceramic capacitor 100 may be manufactured.

Here, as necessary, first and second plating layers (not shown) of nickel (Ni) or tin (Sn) may be further formed on both end surfaces of the ceramic body 110, to cover the first and second external electrodes 131 and 132.

As set forth above, according to the embodiments of the present invention, the dummy patterns are inserted into the margin portions of the active layer in a length direction, and the dummy electrodes are formed in the ceramic body in the upper and lower cover layers thereof, so that step height can be reduced and the occurrence of delamination can be prevented, or, in the case of the occurrence of delamination, the delamination is allowed to occur in the dummy electrodes of the upper and lower cover layers, thereby significantly reducing the penetration of moisture, ions, and conductive foreign objects into exposed surfaces of the internal electrodes through the corners of the ceramic body during the plating process and in the driving environment, whereby deterioration in insulation resistance and reliability of the multilayer ceramic capacitor can be prevented.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor, comprising:
a ceramic body having a plurality of dielectric layers laminated therein;
an active layer including a plurality of first and second internal electrodes alternately exposed through both end surfaces of the ceramic body having the dielectric layer interposed therebetween;
upper and lower cover layers formed above and below the active layer;
first and second external electrodes formed on both end surfaces of the ceramic body and electrically connected to exposed portions of the plurality of first and second internal electrodes, respectively;
a plurality of first and second dummy patterns respectively extended from the first and second external electrodes into margin portions of the active layer in a length direction so as to oppose the plurality of first and second internal electrodes, respectively; and
a plurality of first and second dummy electrodes opposing each other in a length direction in the upper and lower cover layers, the first and second dummy electrodes being extended inwardly from the first and second external electrodes within the upper and lower cover layers.

2. The multilayer ceramic capacitor of claim 1, wherein when a width of the first and second dummy patterns is denoted by a and a gap between the first or second dummy pattern and the first or second internal electrode is denoted by b, 0.2≦a/(a+b)≦0.8 is satisfied.

3. The multilayer ceramic capacitor of claim 1, wherein the first and second dummy patterns have an equal width.

4. The multilayer ceramic capacitor of claim 1, wherein a certain amount of dummy patterns among the plurality of first and second dummy patterns have different widths.

5. The multilayer ceramic capacitor of claim 1, wherein the first and second dummy electrodes have an equal width.

6. The multilayer ceramic capacitor of claim 1, wherein a certain amount of dummy electrodes among the plurality of first and second dummy electrodes have different widths.

7. The multilayer ceramic capacitor of claim 1, wherein the first and second dummy electrodes formed in the upper and lower cover layers are symmetrical with respect to each other in a thickness direction of the ceramic body.

8. The multilayer ceramic capacitor of claim 1, wherein the lower cover layer has a greater thickness than that of the upper cover layer.

9. The multilayer ceramic capacitor of claim 1, further comprising first and second plating layers formed on both end surfaces of the ceramic body to cover the first and second external electrodes.

10. A method of manufacturing a multilayer ceramic capacitor, the method comprising:
laminating a plurality of first ceramic green sheets having a plurality of first and second dummy electrodes respectively formed thereon, laminating an active layer formed by alternately laminating a plurality of second ceramic green sheets and a plurality of third ceramic green sheets, the second ceramic green sheet having a first internal electrode and a first dummy pattern formed thereon, the third ceramic green sheet having a second internal electrode and a second dummy pattern formed thereon, and laminating a plurality of fourth ceramic green sheets having a plurality of first and second dummy electrodes respectively formed thereon, to thereby form a laminate;
cutting the laminate into ceramic bodies while allowing the first and second dummy electrodes of upper and lower portions of the laminate, the first and second internal electrodes and the first and second dummy patterns to be exposed through both end surfaces of the respective ceramic bodies;
sintering the respective ceramic bodies; and
forming first and second external electrodes on both end surfaces of the respective ceramic bodies to cover exposed portions of the first and second dummy electrodes, the first and second internal electrodes, and the first and second dummy patterns.

11. The method of claim 10, wherein in the forming of the laminate, the first and second dummy patterns and the first and second internal electrodes are formed on the second and third ceramic green sheets, respectively, such that 0.2≦a/(a+b)≦0.8 is satisfied when a width of the first and second dummy patterns is denoted by a and a gap between the first or second dummy pattern and the first or second internal electrode is denoted by b.

12. The method of claim 10, wherein in the forming of the laminate, the first and second dummy patterns are formed on the second and third ceramic green sheets, respectively, such that the first and second dummy patterns have an equal width.

13. The method of claim 10, wherein in the forming of the laminate, the first and second dummy patterns are formed on the second and third ceramic green sheets, respectively, such that a certain amount of dummy patterns among the first and second dummy patterns have different widths.

14. The method of claim 10, wherein in the forming of the laminate, the first and second dummy electrodes are formed on the first and fourth ceramic green sheets, such that the first and second dummy electrodes have an equal width.

15. The method of claim 10, wherein in the forming of the laminate, the first and second dummy electrodes are formed on the first and fourth ceramic green sheets, such that a certain amount of dummy patterns among the first and second dummy electrodes have different widths.

16. The method of claim 10, wherein in the forming of the laminate, the first and second dummy electrodes are formed on the first and fourth ceramic green sheets such that the first and second dummy electrodes are symmetrical with respect to each other in a thickness direction of the respective ceramic bodies.

17. The method of claim 10, wherein in the forming of the laminate, the lower portion of the laminate has a greater thickness than that of the upper portion of the laminate by laminating the first ceramic green sheets in greater amounts than the fourth ceramic green sheets.

18. The method of claim 10, further comprising, after the forming of the first and second external electrodes, forming first and second plating layers on both end surfaces of the respective ceramic bodies to cover the first and second external electrodes.
